(19) United States
(12) Patent Application Publication
(10) Pub. No.: US 2017/0242642 A1
(43) Pub. Date: Aug. 24, 2017

(54) PERIPHERAL DEVICE JOB DIRECTION

(71) Applicant: HEWLETT-PACKARD DEVELOPMENT COMPANY, L.P., Houston, TX (US)

(72) Inventors: Jeremy BARRIBEAU, Vancouver, WA (US); Peter G. HWANG, Vancouver, WA (US)

(21) Appl. No.: 15/047,549

(22) Filed: Feb. 18, 2016

(51) Int. Cl. G06F 3/12

(52) U.S. Cl. CPC G06F 3/1268; G06F 3/1203

(57) ABSTRACT

Examples disclosed herein relate to identifying a plurality of available peripheral devices, receiving a job for a first peripheral device of the plurality of peripheral devices, determining whether to direct the job to a second peripheral device of the plurality of peripheral devices, and in response to determining to direct the job to a second peripheral device of the plurality of peripheral devices, causing the job to be directed to the second peripheral device instead of the first peripheral device.

### BACKGROUND

In some situations, a user may desire to send jobs to peripheral devices, such, as sending a document to a printer to be printed. Oftentimes, the user may have multiple peripheral devices from which to select. These peripheral devices may offer different features and properties for processing the jobs directed to them.

### BRIEF DESCRIPTION OF THE DRAWINGS

In the accompanying drawings, like numerals refer to like components or blocks. The following detailed description references the drawings, wherein:

FIG. 1 is a block diagram of an example job direction environment;

FIG. 2 is a block diagram of an example job direction device;

FIG. 3 is a flowchart of an example of a method for providing job direction; and

FIG. 4 is a block diagram of an example system for providing job directions.

### DETAILED DESCRIPTION

In some situations, multiple peripheral devices may be available in an environment, such as an office in which numerous copiers, scanners, printers, multi-function devices, etc. are installed. Such peripheral devices may enable the automatic establishment of a network amongst devices existing within relatively close geographic proximity, such as within the same organization, company, office building, etc. A mesh and/or peer-to-peer network may be established by the printers automatically and without the need far complex network infrastructure or print servers. A plurality of existing communication protocols/technologies could be leveraged to facilitate this functionality, such as WiFi and Bluetooth for wireless communication and/or TCP/IP communications over wired connections.

Each device of the mesh network may be made aware of the status and abilities of neighboring or nearby devices. These devices may then choose to collaborate with said printers to deliver an improved experience to its users. For example, in the event of an unexpected error, one printer could forward its current print queue and/or remaining unprinted pages to another suitable printer. For another example, one printer may automatically split, and/or suggest splitting, a large print job between two neighboring printers, so that the overall print time will be halved. In another example, an incorrectly selected printer may notify its user of an alternate nearby printer more suited to printing their particular content (e.g., a selected monochrome printer may redirect a color print job to a color-capable printer). The user need not have been aware of the existence/location of the more suitable printer due to the exchange of information amongst the devices of the mesh network. For another example, a flatbed scanner may detect that a user is attempting to scan a large number of pages, such as by repeated opening and closing of the flatbed lid, and may prompt the user viva control panel display to use a nearby scanning device with a page feeder tray.

In some implementations of the above examples, as well as other potential applications, one peripheral device may serve as a relay for jobs to be performed. The job's content may be stored on the device's local memory. The device may transfer the data for the job directly to another device and/or relayed via other devices, as is the nature of a mesh network.

When a user selects a known and/or familiar device to process a job, they may be unaware of other available devices and/or the features available on other devices. Selecting a known device may yield success in completing the job, but issues may arise when the selected device suffers from an impasse which is either unrecoverable or inconvenient for the user to deal with. For example, print jams, hardware failures, exhausted supplies, etc. may result in delays or failures to complete the job.

By imparting a degree of spatial awareness to printers existing in a multi-printer deployment environment (e.g. enterprise, education, business center, etc.), solutions to overcome errors may be provided to users. By communicating with a multitude of devices, each device's relative location may be deduced by using its inbuilt wireless communications radio(s) (e.g., triangulation via multiple WiFi signals).

For example, a WiFi positioning system may be used to determine a relative spacing, direction, and/or location for each of the devices. In some implementations, a technique used for WiFi positioning with wireless access points may be based on measuring the intensity of the received signal (received signal strength indication or RSSI) and the method of fingerprinting, or recording of the signal strength from several access points in range and storing this information in a database along with the known coordinates of the device. Typical parameters useful to geolocate the Wi-Fi device include the SSID and the MAC address of the device. The accuracy depends on the number of positions that have been entered into the database. The Wi-Fi device database may be filled by correlating mobile device GPS location data with Wi-Fi device MAC addresses.

The devices may exchange, and thus be aware of, nearby devices capabilities and statuses, thus allowing the devices to make actionable recommendations to the user and/or automatically effect the recovery or continuation of a job should a device issue or error arise. Recommendations may be delivered to users via the device's control panel, an application, such as a mobile app or web page, and/or a driver interface. The device may be capable of forwarding the necessary job data to the selected neighboring device.

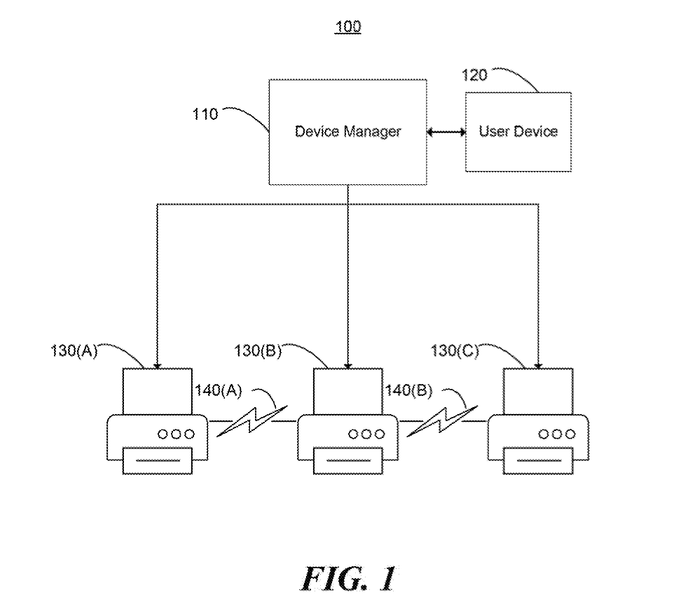

Referring now to the drawings, FIG. 1 is a block diagram of an example job direction environment 100. Environment 100 may comprise a device manager 110, a user device 120, a plurality of peripheral devices 130(A)-(C), and a plurality of networking connections 140(A)-(B). Device manager 110 may reside and operate, on one of plurality of peripheral devices 130(A)-(C), user device 120, and/or another computing device (not shown). Connections 140(A)-(B) may comprise any communication medium and/or protocol to allow the exchange of data among peripheral devices 130(A)-(B) such as wired networking, wireless networking (WiFi), cellular, Bluetooth, etc.

In some implementations, device manager 110 may receive a job from user device 120 for a selected one of peripheral devices 130(A)-(C). The job may be analyzed and compared to the capabilities and status of the selected peripheral device. If an error condition or capability impairs the ability of the selected peripheral device to process the job, device manager 110 may cause the job to be directed to another of peripheral devices 130(A)-(C). For example, a user may submit a document to be printed to peripheral device 130(A). If device manager 110 detects that the document is formatted for A4 paper, and peripheral device 130(A) is out of A4 paper but peripheral device 130(B) is not, the device manager 110 may recommend using device 130(B) instead of device 130(A). In some implementations, the recommendation may take the form of automatically redirecting the print job to device 130(B) and displaying a notification of the redirection to the user. In some implementations, the recommendation may take the form of displaying a suggestion to the user in the form of a decision element for the user to decide and input a selection of whether or not to accept the recommendation. The display of the notification and/or suggestion may occur, for example, on a control panel display of device 130(A) and/or user device 120.

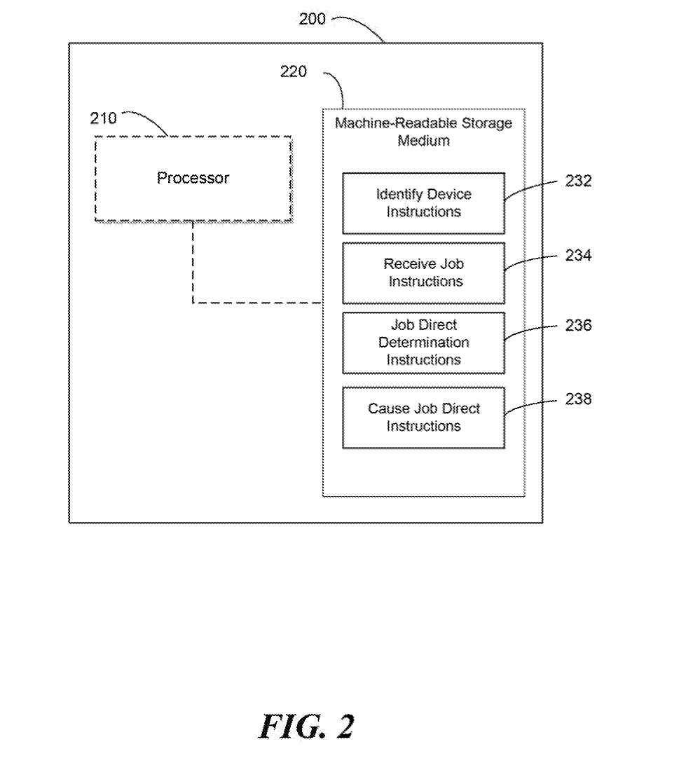

FIG. 2 is a block diagram of an example job direction device 200 consistent with disclosed implementations. Job direction device 200 may comprise a processor 110 and a non-transitory machine-readable storage medium 220. Job direction device 100 may comprise a computing device such as a server computer, a desktop computer, a laptop computer, a handheld computing device, a smart phone, a tablet computing device, a mobile phone, a network device (e.g., a switch and/or router), or the like.

Processor 210 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 220. In particular, processor 210 may fetch, decode, and execute a plurality of identify device instructions 232, receive job instructions 234, job direct determination instructions 236, and cause job direct instructions 238 to implement the functionality described in detail below.

Executable instructions may comprise logic stored in any portion and/or component of machine-readable storage medium 220 and executable by processor 210. The machine-readable storage medium 220 may comprise both volatile and/or nonvolatile memory and data storage components. Volatile components are those that do not retain data values upon loss of power. Nonvolatile components are those that retain data upon a loss of power.

The machine-readable storage medium 220 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Identify device instructions 232 may identify a plurality of available peripheral devices. The plurality of available peripheral devices may, for example, each be associated with an organization, business, user, and/or location. In some implementations, the plurality of available peripheral devices may each accessible by a user, such as being geographically proximate (e.g., located on the same floor as the user) and/or accepting a login credential associated with the user. In some implementations, identify device instructions 232 may identify a plurality of properties associated with each of the available peripheral devices.

Receive job instructions 234 may receive a job for a first peripheral device of the plurality of peripheral devices. For example, a user may submit a print job or request that a copy or scan job start at a multi-function peripheral device, such as an all-in-one printer/copier/scanner. The job may be submitted from the users computer and/or mobile device, for example.

Job direct determination instructions 236 may determine whether to direct the job to a second peripheral device of the plurality of peripheral devices. For example, job direct determination instructions 236 may determine whether the first peripheral device comprises an error state, such as a paper jam, out of supply (e.g., ink or toner), out of paper, network connection failure, or the like. In some implementations, job direct determination instructions 236 may determine that another device is better suited to the job, such as by recognizing that a large print job (e.g., over 100 pages) may be completed faster at a printer with a higher page per minute property and/or by splitting the job amongst multiple devices.

In some implementations, the determination may make use of known locations, such as may be determined via WiFi triangulation, to direct the job to a more convenient device. For example, the job may be redirected to a similar device that is closer to the user, but which the user may have been unaware of and/or to remedy an incorrectly selected device, such as a device on a different floor or office. Further, a user's geolocation may be captured by the mesh network and utilized externally for other purposes, such as locating a user's current approximate position within an office building as part of a mobile way finding application to aid the user in finding the device to which the job has been directed.

Cause job direct instructions 238 may, in response to determining to direct the job to a second peripheral device of the plurality of peripheral devices, cause the job to be directed to the second peripheral device instead of the first peripheral device. For example, a print job may be received and stored in a memory of a first printer, which then determines that a second printer is better suited to completing the job. The printer may, automatically and/or after user authorization, forward the stored job to the second printer over a mesh network shared amongst the plurality of geographically proximate peripheral devices.

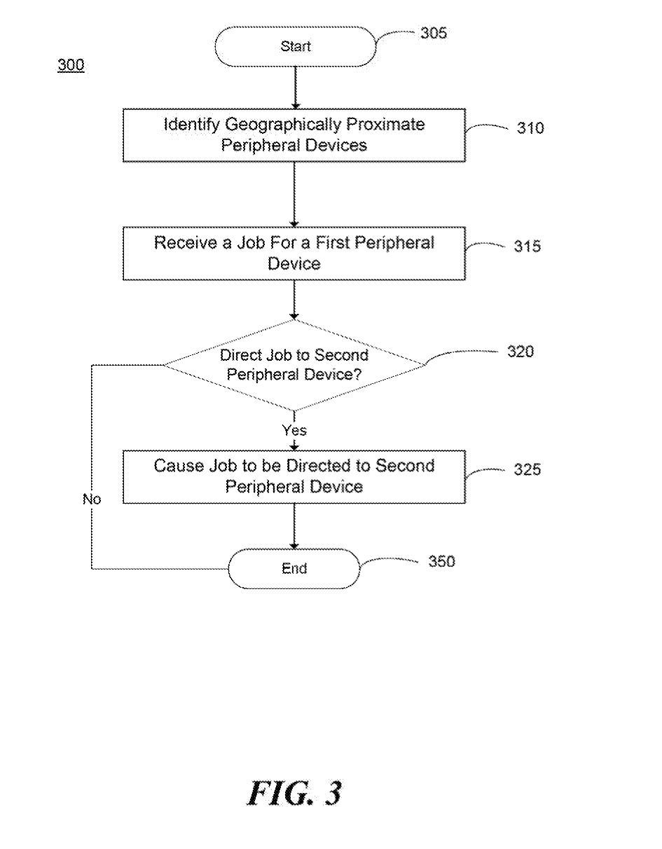

FIG. 3 is a flowchart of an example method 300 for providing job direction consistent with disclosed implementations. Although execution of method 400 is described below with reference to device 200, other suitable components for execution of method 300 may be used.

Method 300 may begin in stage 305 and proceed to stage 310 where device 200 may identify a plurality of geographically proximate peripheral devices. In some implementations, identifying the plurality of geographically proximate peripheral devices comprises establishing a wireless connection, such as a Bluetooth and/or ad-hoc wireless networking connection, among the plurality of geographically proximate peripheral devices. For example, identify device instructions 232 may identify a plurality of available peripheral devices. The plurality of available peripheral devices may, for example, each be associated with an organization, business, user, and/or location. In some implementations, the plurality of available peripheral devices may each accessible by a user, such as being geographically proximate (e.g., located on the same floor as the user) and/or accepting a login credential associated with the user. In some implementations, identify device instructions 232 may identify a plurality of properties associated with each of the available peripheral devices.

Method 300 may then advance to stage 315 where device 200 may receive a job for a first peripheral device of the plurality of geographically proximate peripheral devices. In some implementations, receive job instructions 234 may receive a job for a first peripheral device of the plurality of peripheral devices. For example, a user may submit a print job or request that a copy or scan job start at a multi-function peripheral device, such as an all-in-one printer/copier/scanner. The job may be submitted from the user's computer and/or mobile device, for example.

Method 300 may then advance to stage 320 where device 200 may determine whether to direct the job to a second peripheral device of the plurality of geographically proximate peripheral devices. In some implementations, job direct determination instructions 236 may determine whether to direct the job to a second peripheral device of the plurality of peripheral devices. For example, job direct determination instructions 236 may determine whether the first peripheral device comprises an error state, such as a paper jam, out of supply (e.g., ink or toner), out of paper, network connection failure, or the like. In some implementations, job direct determination instructions 236 may determine that another device is better suited to the job, such as by recognizing that a large print job (e.g., over 100 pages) may be completed faster at a printer with a higher page per minute property and/or by splitting the job amongst multiple devices.

In some implementations, determining whether to direct the job to a second peripheral device of the plurality of geographically proximate peripheral devices may comprise detecting an error state at the first peripheral device. In some implementations, determining whether to direct the job to the second peripheral device of the plurality of geographically proximate peripheral devices may comprise determining whether the second peripheral device is capable of completing the job faster. In some implementations, determining whether to direct the job to a second peripheral device of the plurality of geographically proximate peripheral devices may comprise determining whether the second peripheral device is capable of completing the job at a lower cost.

In response to determining to direct the job to a second peripheral device of the plurality of geographically proximate peripheral devices, method 300 may then advance to stage 325 where device 200 may cause the job to be directed to the second peripheral device instead of the first peripheral device. In some implementations, cause job direct instructions 238 may, in response to determining to direct the job to a second peripheral device of the plurality of peripheral devices, cause the job to be directed to the second peripheral device instead of the first peripheral device. For example, a print job may be received and stored in a memory of a first printer, which then determines that a second printer is better suited to completing the job. The printer may, automatically and/or after user authorization, forward the stored job to the second printer over a mesh network shared amongst the plurality of geographically proximate peripheral devices.

After determining that the job is not to be directed to a second peripheral device at stage 320 or causing the job to be directed to the second peripheral device at stage 325, method 300 may end at stage 350.

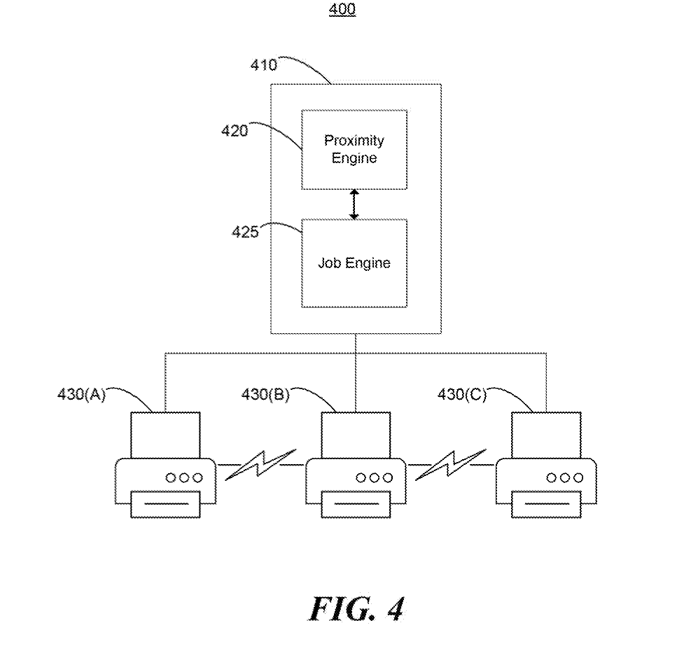

FIG. 4 is a block diagram of an example system 400 for providing job direction. System 400 may comprise a computing device 410 comprising a proximity engine 420 and a job engine 425. Engines 420 and 425 may be associated with a single computing device 410 and/or may be communicatively coupled among different devices such as via a direct connection, bus, or network. Each of engines 420, 425 may comprise hardware and/or software associated with computing devices. System 400 may further comprise a plurality of communicatively coupled peripheral device 430(A)-(C). In some implementations, computing device 410 may also comprise a communicatively coupled peripheral device.

Proximity engine 420 may identify a plurality of geographically proximate peripheral devices and identify a plurality of properties of each of the geographically proximate peripheral devices. In some implementations, receive job instructions 234 may receive a job for a first peripheral device of the plurality of peripheral devices. For example, a user may submit a print job or request that a copy or scan job start at a multi-function peripheral device, such as an all-in-one printer/copier/scanner. The job may be submitted from the user's computer and/or mobile device, for example. Proximity engine 420 may further communicate with each of the peripheral devices 430(A)-(C) to identify capabilities and properties, such as color printing, duplexing, finishing (e.g., stapling, binding, collating, etc.), scanning, delivery functions (e.g., fax and/or email), available media (e.g., paper sizes and types). Proximity engine 420 may also detect and/or identify error conditions on each peripheral device. In some implementations, proximity engine 420 may execute on each of the peripheral devices to collect information about the host device and share that information with nearby devices, such as those connected via the mesh network.

Job engine 425 may receive a job directed to a first peripheral device of the plurality of geographically proximate peripheral devices, determine, according to the plurality of properties of each of the geographically proximate peripheral devices, whether to direct the job to a second peripheral device of the plurality of geographically proximate peripheral devices, and in response to determining to direct the job to a second peripheral device of the plurality of geographically proximate peripheral devices, cause the job to be directed to the second peripheral device instead of the first peripheral device.

Job engine 425 may, for example, execute receive job instructions 234 to receive a job for a first peripheral device of the plurality of peripheral devices. For example, a user may submit a print job or request that a copy or scan job start at a multi-function peripheral device, such as an all-in-one printer/copier/scanner. The job may be submitted from the user's computer and/or mobile device, for example.

For example, job engine 425 may determine whether to direct the job to a second peripheral device of the plurality of geographically proximate peripheral devices. In some implementations, job engine 425 may execute job direct determination instructions 236 to determine whether to direct the job to a second peripheral device of the plurality of peripheral devices. For example, job direct determination instructions 236 may determine whether the first peripheral device comprises an error state, such as a paper jam, out of supply (e.g., ink or toner), out of paper, network connection failure, or the like. In some implementations, job direct determination instructions 236 may determine that another device is better suited to the job, such as by recognizing that a large print job (e.g., over 100 pages) may be completed faster at a printer with a higher page per minute property and/or by splitting the job amongst multiple devices.

In some implementations, determining whether to direct the job to a second peripheral device of the plurality of geographically proximate peripheral devices may comprise detecting an error state at the first peripheral device. In some implementations, determining whether to direct the job to the second peripheral device of the plurality of geographically proximate peripheral devices may comprise determining whether the second peripheral device is capable of completing the job faster. In some implementations, determining whether to direct the job to a second, peripheral device of the plurality of geographically proximate peripheral devices may comprise determining whether the second peripheral device is capable of completing the job at a lower cost.

Job engine 425 may, in response to determining to direct the job to a second peripheral device of the plurality of peripheral devices, execute cause job direct instructions 238 to cause the job to be directed to the second peripheral device instead of the first peripheral device. For example, a print job may be received and stored in a memory of a first printer, which then determines that a second printer is better suited to completing the job. The printer may, automatically and/or after user authorization, forward the stored job to the second printer over a mesh network shared amongst the plurality of geographically proximate peripheral devices.

The disclosed examples may include systems, devices, computer-readable storage media, and methods for job direction. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

1. A non-transitory machine-readable storage medium comprising instructions to:
identify a plurality of available, geographically proximate peripheral devices;
receive a job for a first peripheral device of the plurality of peripheral devices;
determine whether to direct the job to a second peripheral device of the plurality of peripheral devices, wherein the instructions to determine whether to direct the job to the second peripheral device of the plurality of peripheral devices comprise instructions to determine whether the second peripheral device of the plurality of peripheral devices is better suited to the job; and
in response to determining to direct the job to a second peripheral device of the plurality of peripheral devices, cause the job to be directed to the second peripheral device instead of the first peripheral device.

2. The non-transitory machine-readable medium of claim 1, wherein the plurality of available peripheral devices are each associated with an organization.

3. The non-transitory machine-readable medium of claim 1, wherein plurality of available peripheral devices are each accessible by a user.

4. The non-transitory machine-readable medium of claim 3, wherein the plurality of available peripheral devices being each accessible by the user comprise the plurality of available peripheral devices accepting a login credential associated with the user.

5. (canceled)

6. The non-transitory machine-readable medium of claim 1, wherein the instructions to identify the plurality of available peripheral devices further comprise instructions to identify a plurality of properties associated with each of the available peripheral devices.

7. The non-transitory machine-readable medium of claim 1, wherein the instructions to determine whether to direct the job to a second peripheral device of the plurality of peripheral devices comprise instructions to determine whether the first peripheral device comprises an error state.

8. A computer-implemented method, comprising:
identifying a plurality of geographically proximate peripheral devices;
receiving a job for a first peripheral device of the plurality of geographically proximate peripheral devices;
determining whether to direct the job to a second peripheral device of the plurality of geographically proximate peripheral devices wherein determining whether to direct the job to the second peripheral device of the plurality of geographically proximate peripheral devices comprises determining whether the second peripheral device of the plurality of peripheral devices is better suited to the job; and
in response to determining to direct the job to a second peripheral device of the plurality of geographically proximate peripheral devices, causing the job to be directed to the second peripheral device instead of the first peripheral device.

9. The computer-implemented method of claim wherein identifying the plurality of geographically proximate peripheral devices comprises establishing a wireless connection among the plurality of geographically proximate peripheral devices.

10. The computer-implemented method of claim wherein the wireless connection comprises a Bluetooth connection.

11. The computer-implemented method of claim 9, wherein the wireless connection comprises an ad-hoc wireless network connection.

12. The computer-implemented method of claim 8, wherein determining whether to direct the job to a second peripheral device of the plurality of geographically proximate peripheral devices comprises detecting an error state at the first peripheral device.

13. The computer-implemented method of claim 8, wherein determining whether to direct the job to the second peripheral device of the plurality of geographically proximate peripheral devices comprises determining whether the second peripheral device is capable of completing the job faster.

14. The computer-Implemented method of claim 8, wherein determining whether to direct the job to a second peripheral device of the plurality of geographically proximate peripheral devices comprises determining whether the second peripheral device is capable of completing the job at a lower cost.

15. A system, comprising:
a proximity engine to:
identify a plurality of geographically proximate peripheral devices, and
identify a plurality of properties of each of the geographically proximate peripheral devices;
a job engine to:
receive a job directed to a first peripher i device of the plurality of geographically proximate peripheral devices,
determine, according to the plurality of properties of each of the geographically proximate peripheral devices, whether to direct the job to a second peripheral device of the plurality of geographically proximate peripheral devices wherein determining whether to direct the job to the second peripheral device of the plurality of geographically proximate peripheral devices comprises determining whether the second peripheral device of the plurality of peripheral devices is better suited to the lob according to the plurality of properties of each of the geographically proximate peripheral devices, and
in response to determining to direct the job to a second peripheral device of the plurality of geographically proximate peripheral devices, cause at least a portion of the job to be directed to the second peripheral device instead of the first peripheral device.

16. The non-transitory machine-readable storage medium of claim 1, wherein the instructions to determine whether the second peripheral device of the plurality of peripheral devices is better suited to the job comprise instructions to determine whether the second peripheral device has a different capability than the first peripheral device.

17. The non-transitory machine-readable storage medium of claim 1, wherein the instructions to determine whether the second peripheral device of the plurality of peripheral devices is better suited to the job comprise instructions to determine whether the second peripheral device is geographically closer to the user than the first peripheral device.

18. The method of claim 8, wherein determining whether the second peripheral device of the plurality of peripheral devices is better suited to the job comprises determining whether the first peripheral device comprises an incorrectly selected device.

19. The system of claim 15, wherein the job engine causing at least a portion of the job to be directed to the second peripheral device instead of the first peripheral device comprises the job engine to:
split the job into a plurality of portions;
cause a first portion of the job to be completed at the first peripheral device; and
cause a second portion of the job to be completed at the second peripheral device.
